(19) United States
(12) Patent Application Publication
(10) Pub. No.: US 2024/0043099 A1
(43) Pub. Date: Feb. 8, 2024

(54) MOORING SYSTEM

(71) Applicant: AKER SOLUTIONS AS, LYSAKER (NO)

(72) Inventors: YONGYAN WU, RICHMOND, TX (US); ANDREAS WATLE, OPPEGARD (NO); PETER LEITCH, HOUSTON, TX (US); JON HUSBY, HOUSTON, TX (US); DORTHE JULIE KIRKEBY, NITTEDAL (NO)

(73) Assignee: AKER SOLUTIONS AS, LYSAKER (NO)

(21) Appl. No.: 17/880,678

(22) Filed: Aug. 4, 2022

(51) Int. Cl. B63B 21/50

(52) U.S. Cl. CPC B63B 21/508

(57) ABSTRACT

A mooring system includes a floater, a first anchor, a first mooring line, and a second mooring line. The first mooring line and the second mooring line are each connected to the first anchor and extend to the floater. The first mooring line is connected to the floater at a first connection point. The second mooring line is connected to the floater at a second connection point. The first connection point is spaced apart from the second connection point.

### FIELD

The present invention relates to a mooring system, and particularly, but not exclusively to a mooring system for use in anchoring a floating offshore wind turbine installation.

### BACKGROUND

It is known to anchor floaters such as a semi-submersible floating wind turbine installation using a plurality of mooring lines each of which extends from a connection point on the floater to an anchor. Where there are a plurality of floaters, the floaters in the array may share anchors, so that a plurality of mooring lines are attached to each anchor, each mooring line being attached to any one anchor extending to a different floater in the array.

Publications which may be useful to understand the background of the present invention are WO 2022/031175, US 2013/0276687, and WO 2022/098288.

### SUMMARY

In an embodiment, the present invention provides a mooring system which includes a floater, a first anchor, a first mooring line, and a second mooring line. The first mooring line and the second mooring line are each connected to the first anchor and extend to the floater. The first mooring line is connected to the floater at a first connection point. The second mooring line is connected to the floater at a second connection point. The first connection point is spaced apart from the second connection point.

### BRIEF DESCRIPTION OF THE DRAWINGS

The present invention is described in greater detail below on the basis of embodiments and of the drawings in which:

FIG. 1 is a schematic illustration of a plan view of an embodiment of the innovative mooring system of the present invention showing A) a triangular floater, B) a square floater, C) a heptagonal floater, and D) a circular floater;

FIG. 2 is a schematic illustration of a plan view of an alternative embodiment of mooring system of the present invention;

FIG. 3 is a schematic illustration of a plan view of the mooring system shown in FIG. 2 as part of an array of mooring systems;

FIG. 4 is a schematic illustration of a plan view of an alternative embodiment of a mooring system of the present invention;

FIG. 5 is a schematic illustration of a plan view of the mooring system shown in FIG. 4 as part of an array of mooring systems;

FIG. 6 is a schematic illustration of a plan view of an alternative embodiment of mooring system not in accordance with the present invention;

FIG. 7 shows three examples (A-C) of floaters suitable for use in the innovative mooring systems of the present invention where each floater comprises a plurality of buoyant elements which are connected by rigid connecting elements;

FIG. 8 is a plan view of part of an embodiment of a mooring system showing the connectors via which the mooring lines are connected to the floater;

FIG. 9 is a side view of part of an alternative embodiment of a mooring system of the present invention showing the connectors via which the mooring lines are connected to the floater; and

FIG. 10 is a perspective view of an embodiment of a floating off-shore wind turbine installation which may comprise the floater of the mooring systems according to the present invention.

### DETAILED DESCRIPTION

An embodiment of the present invention provides a mooring system comprising a floater, a first anchor, and first and second mooring lines, the first and second mooring lines being secured to the first anchor and extending to the floater, the first mooring line being secured to the floater at a first connection point, and the second mooring line being secured to the floater at a second connection point, the first connection point being spaced from the second connection point.

The system may comprise a second anchor and a third mooring line which is connected to the second anchor and extends from the second anchor to the floater, the third mooring line being connected to the floater at a third connection point which is spaced from the first and second connection points.

The system may comprise a third anchor and a fourth mooring line which is connected to the third anchor and extends from the third anchor to the floater, the fourth mooring line being connected to the floater at a fourth connection point which is at or adjacent the third connection point.

The fourth mooring line may alternatively be connected to the floater at a fourth connection point which is spaced from the first, second and third connection points.

The system may alternatively comprise a fourth mooring line which is connected to the second anchor and extends from the second anchor to the floater, the fourth mooring line being connected to the floater at a fourth connection point which is at or adjacent to either the first or second connection point.

The floater may comprise a foundation structure. The foundation structure may have a plurality of corners, the first mooring point being provided at a first one of the corners, and the second mooring point being provided at a second one of the corners. Where the foundation structure is provided with more than three corners, the first and second mooring points may be provided at adjacent corners.

The foundation structure may comprise a platform formed from a plurality of buoyant elements joined by a plurality of generally rigid connectors, a buoyant element being provided at each corner of the foundation structure. The foundation structure may comprise, for example, three buoyant elements arranged in a triangular array. The base may alternatively comprise four buoyant elements arranged in a square or rectangular array. The base may further alternatively comprise more than four buoyant elements arranged in a polygon array, with a buoyant element being provided at each corner of the polygon.

The floater may further comprise a wind turbine supported on the foundation structure.

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the present invention. The terms are used for the reader's convenience only and shall not be limiting.

In all the drawings, the mooring system 10 is illustrated schematically as if viewed from directly above when the floater is floating on a body of water.

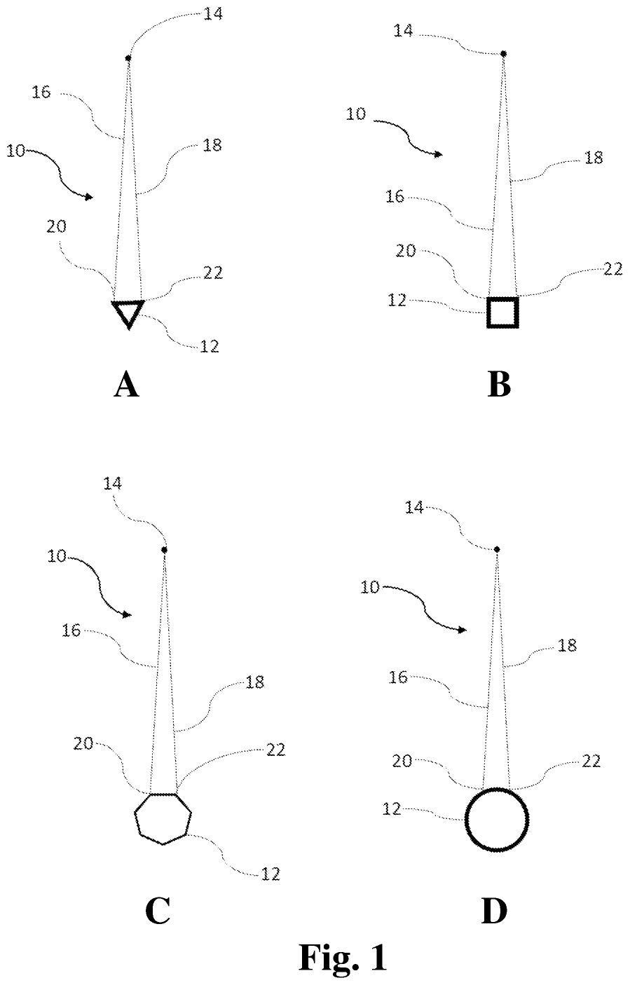

FIG. 1A-D show a mooring system 10 comprising a floater 12, a first anchor 14 and first and second mooring lines 16, 18, the first and second mooring lines 16, 18 being secured to the first anchor 14 and extending to the floater 12, the first mooring line 16 being secured to the floater 12 at a first connection point 20, and the second mooring line 18 being secured to the floater 12 at a second connection point 22, the first connection point 20 being spaced from the second connection point 22. The first mooring line 16 is separate from the second mooring line 18 along the entire length from the floater 12 to the first anchor 14 in the sense that from their point of connection to the first anchor 14 to their point of connection to the floater 12, the first mooring line 16 and second mooring line 18 extend along entirely separate paths.

The first and second connection points 20, 22 are advantageously arranged so that when the floater 12 is floating on a calm body of water, a line connecting the first and second connection points 20, 22 is generally horizontal. This line need not be exactly horizontal, but there should, however, be a significant horizontal separation between the first and second connection points 20, 22.

In the embodiment illustrated in A of FIG. 1, the floater 12 is generally triangular in a plan view cross-section (i.e., parallel to the water surface), and the first and second connection points 20, 22 are located at or adjacent to two of the three corners of the triangle.

In an alternative embodiment illustrated in B of FIG. 1, the floater 12 is square in a plan view cross-section (i.e., parallel to the water surface), and the first and second connection points 20, 22 are located at or adjacent to two adjacent corners of the square.

The floater may equally be annular or circular, or a polygon in a plan view, with more than 4 sides. In the embodiment illustrated in C of FIG. 1, the floater 12 is heptagonal, and the first and second connection points 20, 22 are located at or adjacent to two adjacent corners of the heptagon. In the embodiment illustrated in D of FIG. 1, the floater 12 is circular, and the first and second connection points 20, 22 are spaced along the circumference of the floater 12.

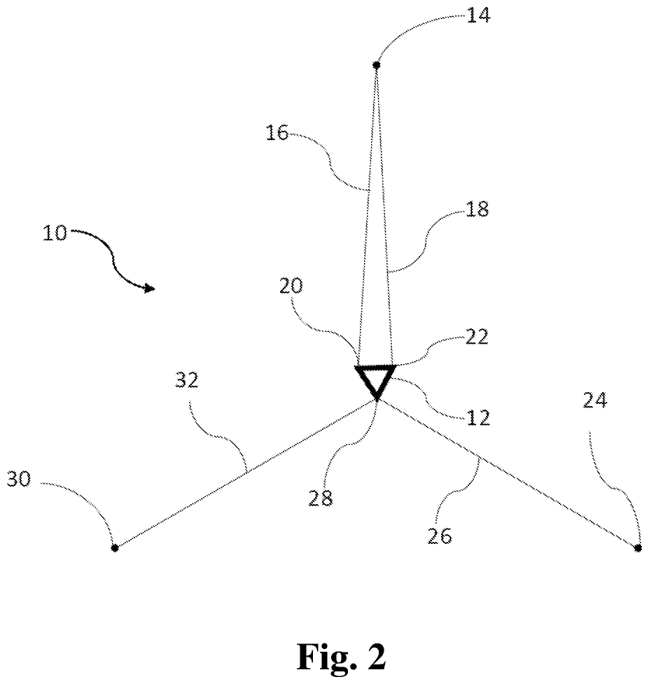

It will be appreciated that in the arrangements illustrated in A-D of FIG. 1, the first anchor 14 and mooring lines 16, 18 will prevent the floater 12 from moving when subjected to forces acting parallel to a line between the first anchor 14 and the floater 12 pushing the floater 12 away from the first anchor 14. In order to restrain the floater 12 when subjected to forces acting in other directions, the mooring system advantageously comprises a second anchor 24 and a third mooring line 26 which is connected to the second anchor 24 and which extends from the second anchor 24 to the floater 12, the third mooring line 26 being connected to the floater 12 at a third connection point 28 which is spaced from the first and second connection points 20, 22, as is illustrated in FIG. 2.

While FIG. 2 shows this in relation to a triangular floater, it will be appreciated that this could also be applied to any of the floaters illustrated in and described in relation to A-D of FIG. 1.

In the embodiment illustrated in FIG. 2, the mooring system 10 further comprises a third anchor 30 and a fourth mooring line 32 which is connected to the third anchor 30 and which extends from the third anchor 30 to the floater 12, the fourth mooring line 32 being connected to the floater 12 at a fourth connection point which is at or adjacent the third connection point 28.

The first, second and third anchors 14, 24, 30 are generally evenly spaced around the floater 12, so if the mooring lines 16, 18, 26, 32 are all taut, a generally horizontal movement of the floater 12 in any direction is significantly restricted. It will be appreciated by a person of skill in the art that, in practice, the mooring lines 16, 18, 26, 32 will never be completely taut. In order to extend from the floater 12 at the water surface to the anchors 14, 24, 30 at the seabed, the mooring lines 16, 18, 26, 32 can be very long and heavy, and therefore tend to follow an arcuate path from the floater 12 to the anchors 14, 24, 30, as is illustrated, for example, in FIG. 13 of US 2013/0276687. This is generally known to persons of skill in the art as a “catenary” mooring system. The weight of the mooring lines 16, 18, 26, 32 will, however, provide a force which resists the mooring lines 16, 18, 26, 32 from straightening any further, and thus horizontal movement of the floater 12 will, nonetheless, be substantially prevented or at least significantly restricted.

It should also be appreciated that while the first, second and third anchors 14, 24, 30 may be generally evenly spaced around the floater 12, this need not be the case. Depending on the prevailing environmental loads (prevailing wind direction, tide, currents etc.), two of the anchors 14, 24, 30 may be closer to each other than they are to the other anchor.

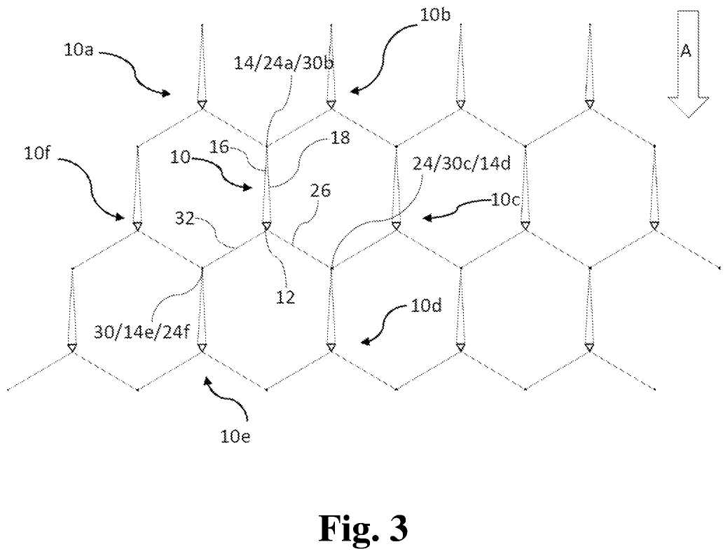

The floater 12 may be provided in an array of floaters as illustrated in FIG. 3.

In this embodiment, the different floaters 12 in the array share anchors. The first anchor 14 of one mooring system 10 is the second anchor 24a of another mooring system 10a and the third anchor 30b of yet another mooring system 10b. Similarly, the second anchor 24 of the mooring system 10 is the third anchor 30c of another mooring system 10c and the first anchor 14d of yet another mooring system 10d, and the third anchor 30 is the first anchor 14e of yet another mooring system 10e and the second anchor 24f of yet another mooring system 10f. As such, it will be appreciated that for all the mooring systems which are not at the edge of the array, four mooring lines are connected to each anchor 14, 24, 30.

The array is typically arranged so that the mooring systems 10, 10a, 10b, 10c, 10e and 10f are arranged so that the prevailing direction of the environmental loads (e.g., winds, waves, and/or current loads—as indicated by arrow A) is parallel to a line between the first anchor 14 and the floater 12 and directed to drive the floater 12 away from the first anchor 14.

As mentioned above, the same principle may be applied to the other types of floaters illustrated in B-D of FIG. 1. In these cases, however, the fourth mooring line 32 may be connected to the floater at a fourth connection point which is spaced from the first, second and third connection points 20, 22, 28. For example, where the floater 12 is generally square or rectangular, each of the first, second, third or fourth mooring lines 16, 18, 26, 32 may be connected to connection point at or adjacent a different corner of the floater 12.

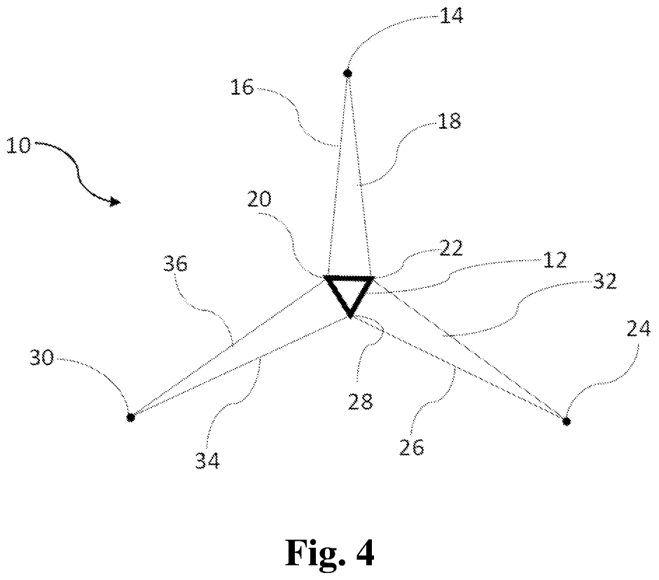

A further alternative embodiment is illustrated in FIG. 4. In this embodiment, the fourth mooring line 32 is connected to the second anchor 24 and extends from the second anchor 24 to the floater 12, and is connected to the floater 12 at a fourth connection point which is at or adjacent to the second connection point 22.

In this embodiment, the system 10 also has a third anchor 30, and fifth and sixth mooring lines 34, 36 extend from the third anchor 30 to the floater 12. The fifth mooring line 34 is connected to the floater 12 at a fifth connection point 33 which is at or adjacent to the third connection point 28, while the sixth mooring line 36 is connected to the floater at a sixth connection point which is at or adjacent the first connection point 20.

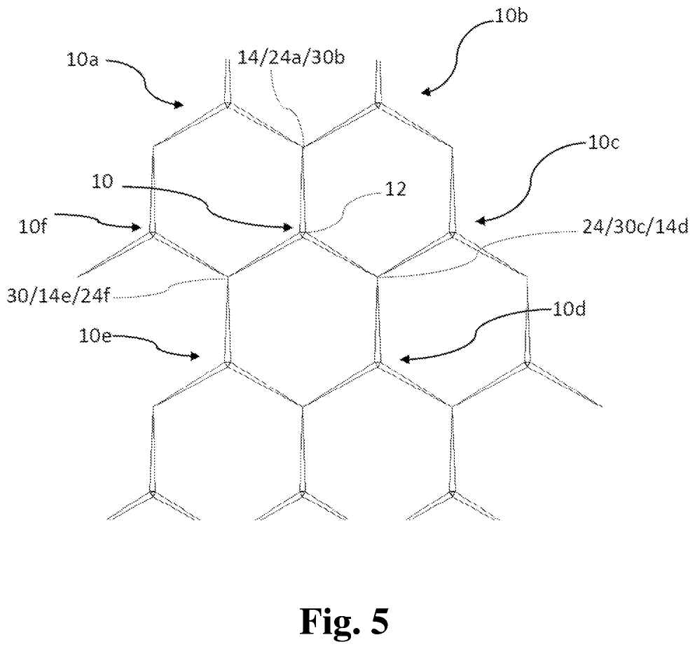

The mooring system 10 may be provided in an array of mooring systems as illustrated in FIG. 5.

As specified in relation to FIG. 3 above, the different floaters 12 in the array share anchors. The first anchor 14 of one mooring system 10 is the second anchor 24a of another mooring system 10a, and the third anchor 30b of yet another mooring system 10b. Similarly, the second anchor 24 of the mooring system 10 is the third anchor 30c of another mooring system 10c, and the first anchor 14d of yet another mooring system 10d, and the third anchor 30 is the first anchor 14e of yet another mooring system 10e, and the second anchor 24f of yet another mooring system 10f. As such, it will be appreciated that for all the anchors which are not at the edge of the array, four mooring lines are connected to each anchor 14, 24, 30.

Also as specified in relation to FIGS. 2 and 3 above, the first, second and third anchors 14, 24, 30 are generally evenly spaced around the floater 12, so if the mooring lines 16, 18, 26, 32 are all taut (or in a catenary arrangement as discussed above), a generally horizontal movement of the floater 12 in any direction is substantially prevented or at least significantly restricted.

In any of the embodiments described above, the floater 12 may comprise a foundation structure which has a plurality of corners, each of the connection points being provided at one of the corners.

The foundation structure may comprise a platform formed from a plurality of buoyant elements 12a joined by a plurality of generally rigid connecting elements 12b. The connecting elements 12b may, for example, comprise trusses, pontoons or other means for bracing. A buoyant element 12a is advantageously provided at each corner of the array, the first and second connection points 20, 22 being provided on different buoyant elements 12a.

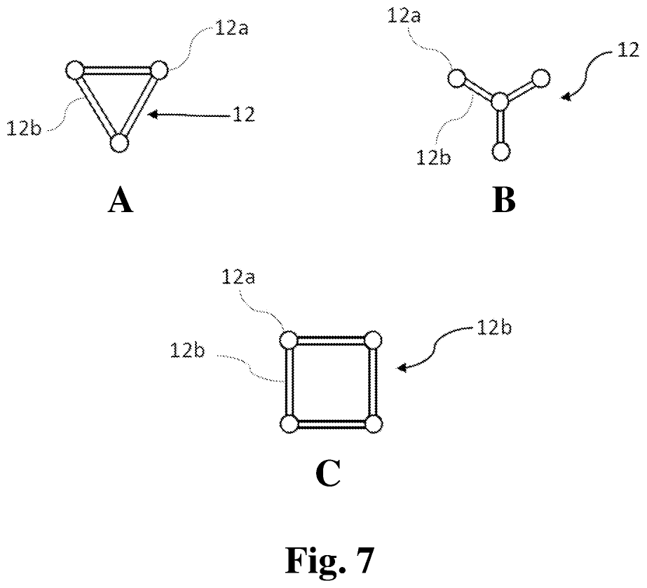

Various possible arrangements of such foundation structures are illustrated in A-C of FIG. 7, with the buoyancy elements 12a drawn as circles, and joined by connecting elements 12b. The foundation structure may comprise three buoyant elements 12a arranged in a triangular array as illustrated in A and B of FIG. 7. The foundation structure may alternatively comprise four buoyant elements 12a arranged in a square or rectangular array as illustrated in C of FIG. 7. Further alternatively, the foundation structure may comprise more than four buoyant elements 12a arranged in a polygonal or generally circular array. The first and second connection points are typically provided on adjacent buoyant elements 12a, but this need not necessarily be the case.

The floater 12 may be a semi-submersible platform of the sort described in US 2013/0276687, which comprises a plurality of generally vertical buoyancy columns coupled together with a tubular truss system that includes horizontal and vertical bracing beams with a horizontal water-entrapment plate attached to the lowermost portion of some or all of the columns. While all of the columns may be substantially hollow buoyancy columns, this need not be the case. Some of the columns may, for example, be substantially hollow buoyancy columns, while the others are stabilizing columns. Where the foundation structure is provided with a mixture of buoyancy columns and stabilizing columns, the connection points 20, 22, 28 could be provided on buoyancy columns only, stabilizing columns only, or as a mixture of buoyancy columns and stabilized columns. It should be appreciated that the floater 12 could equally comprise a single, continuous buoyant element,

The floater 12 may further comprise a wind turbine 50 supported on the foundation structure 48, as illustrated in FIG. 10. Where the foundation structure 48 is formed from a plurality of columns, the wind turbine 50 may be mounted directly above one buoyancy column which provides some or all of the buoyant force required to support the weight of the wind turbine 50, the other columns including a ballast system, and therefore acting as stabilizing columns to stabilize the foundation structure. The wind turbine could alternatively be supported symmetrically by all of the columns. Examples of such a floating wind turbine installation is illustrated and described in at least US 2013/0276687.

More than one wind turbine could be mounted on the foundation structure. Another energy generating apparatus, such as a solar panel, could also be mounted on the foundation structure in addition to a wind turbine.

The floater 12 could equally be a fish farm, or an array of floating solar panels.

The or each anchor 14, 24, 30 may be a dead weight anchor, a driven pile, a drag anchor, a suction pile, a torpedo pile, a vertical load anchor, or any other suitable form of anchor device.

The mooring lines 16, 18, 26, 32, 34, 36 may be chains, ropes or cables, and may be made from metal or polymers such as polyester, nylon, or high modulus polyethylene. The mooring lines 16, 18, 26, 32, 34, 36 need not be all be made from the same material or be of the same construction; some may be chains, others ropes etc.

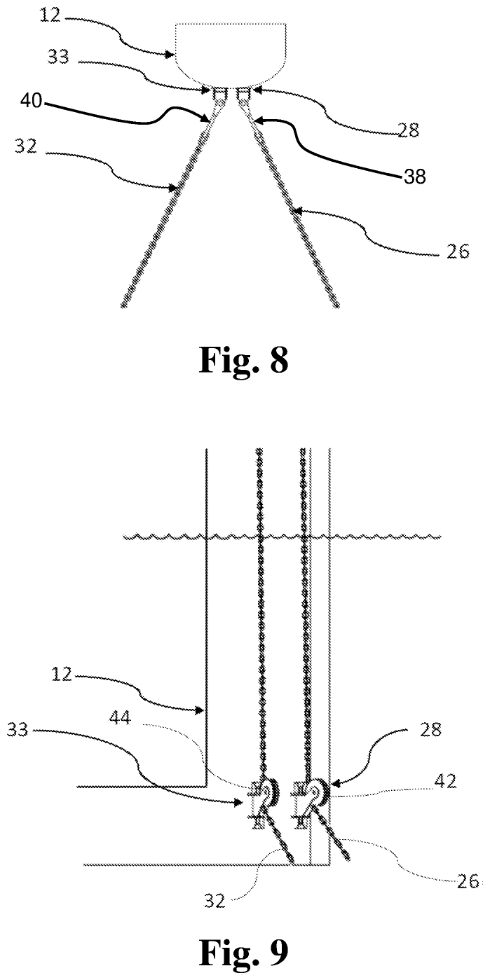

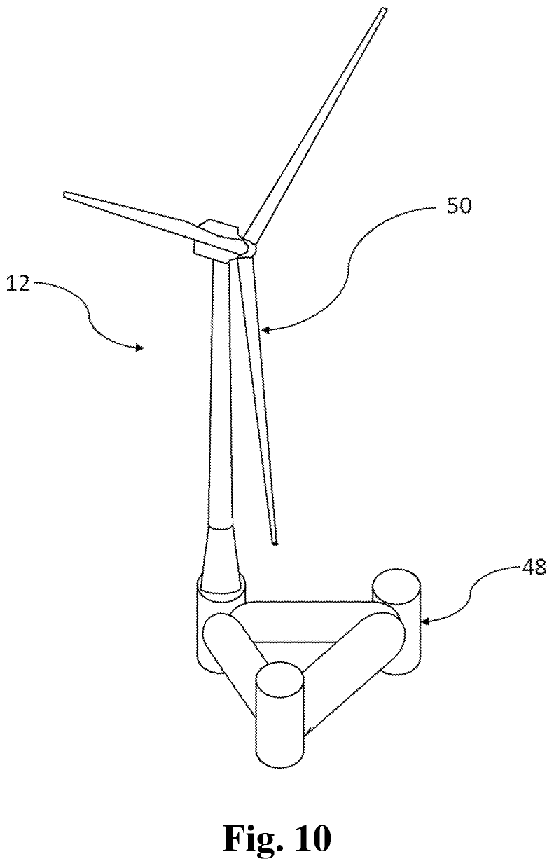

Each mooring line 16, 18, 26, 32, 34, 36 may be connected to the floater 12 using a connector such as a fairlead or bi-axial joint, as illustrated in FIGS. 8 and 9. FIG. 8 shows one corner of the floater 12 in a plan view, specifically the corner to which the third and fifth mooring lines 26, 32 are secured. In this embodiment, the mooring lines 26, 32 are chains and are each connected to the floater 12 via a bi-axial joint connector 38, 40 at the third and fifth connection points 28, 33 respectively. FIG. 9 shows the same corner of the floater 12, but this time as a side view. In this embodiment, the floater 12 comprises a column at each corner, and the mooring lines 26, 32 are again chains, but in this embodiment, each is secured to the floater by means of a fair-lead 42, 44

Where a mooring line is connected to the floater 12 at a connection point which is at or adjacent to the connection point associated with a different mooring line, while both mooring lines could be connected to the same connector, typically this will not be the case, and each mooring line will be provided with its own connector. The connectors may in this case be mounted side-by-side on the floater 12 as illustrated in FIGS. 8 and 9, or they may simply be secured to the same buoyant element.

By virtue of connecting two separate mooring lines (each of which extend from two different and horizontally spaced connection points on the floater all the way to the anchor) to the same anchor, the number of anchors used to restrain the floater 12 may be reduced, thus reducing the cost, both in terms of equipment and installation, and environmental impact on the sea floor of the mooring system 10.

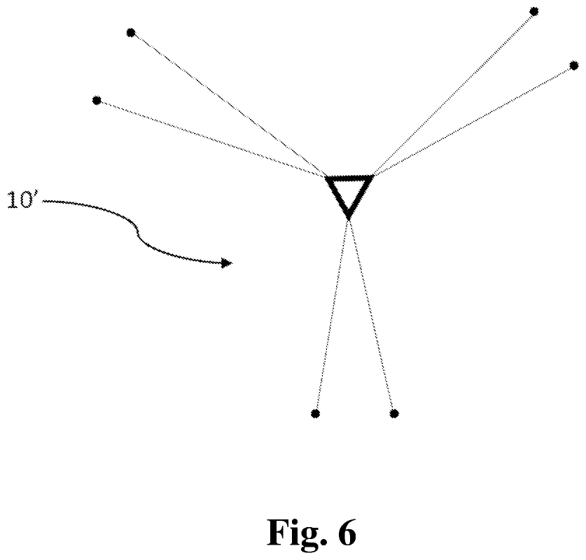

In fact, computer simulations carried out reveal that when compared with the mooring system 10′ illustrated in FIG. 6, in which each mooring line is connected to a separate anchor, with the new mooring system illustrated in FIG. 4, the restoring forces acting to resist translational movement of the floater 12 in two perpendicular directions are likely to be substantially the same for both systems, while the yaw stiffness (i.e., resistance to rotation of the floater 12 about a generally horizontal axis) of the new mooring system 10 illustrated in FIG. 4 may be increased compared to the system 10′ illustrated in FIG. 6.

The invention is not limited by the embodiments described above; reference should be had to the appended claims.

### LIST OF REFERENCE NUMERALS

10 Mooring system
10′ Mooring system
10a-f Mooring system
12 Floater
12a Buoyant element
12b Connecting element
14 First anchor
14d-e First anchor
16 First mooring line
18 Second mooring line
20 First connection point
22 Second connection point
24 Second anchor
24a, f Second anchor
26 Third mooring line
28 Third connection point
30 Third anchor
30b-c Third anchor
32 Fourth mooring line
33 Fifth connection point
34 Fifth mooring line
36 Sixth mooring line
38 Bi-axial joint connector
40 Bi-axial joint connector
42 Fair-lead
44 Fair-lead
48 Foundation structure
50 Wind turbine

What is claimed is:

1. A mooring system comprising:
a floater;
a first anchor;
a first mooring line; and
a second mooring line,
wherein,
the first mooring line and the second mooring line are each connected to the first anchor and extend to the floater,
the first mooring line is connected to the floater at a first connection point,
the second mooring line is connected to the floater at a second connection point, and
the first connection point is spaced apart from the second connection point.

2. The mooring system as recited in claim 1, further comprising:
a second anchor; and
a third mooring line,
wherein,
the third mooring line is connected to the second anchor and extends from the second anchor to the floater, and
the third mooring line is connected to the floater at a third connection point which is spaced apart from the first connection point and the second connection point.

3. The mooring system as recited in claim 2, further comprising;
a third anchor; and
a fourth mooring line,
wherein,
the fourth mooring line is connected to the third anchor and extends from the third anchor to the floater, and
the fourth mooring line is connected to the floater at a fourth connection point which is at or adjacent to the third connection point.

4. The mooring system as recited in claim 2, further comprising:
a third anchor; and
a fourth mooring line which is connected to the third anchor and extends from the third anchor to the floater,
wherein,
the fourth mooring line is connected to the floater at a fourth connection point which is spaced from the first connection point, the second connection point, and the third connection point.

5. The mooring system as recited in claim 2, further comprising:
a fourth mooring line,
wherein,
the fourth mooring line is connected to the second anchor and extends from the second anchor to the floater, and
the fourth mooring line is connected to the floater at a fourth connection point which is at or adjacent to either the first connection point or the second connection point.

6. The mooring system as recited in claim 1, wherein,
the floater comprises a foundation structure which includes a plurality of corners,
the first connection point is provided on a first one of the plurality of corners, and
the second connection point is provided on a second one of the plurality of corners.

7. The mooring system as recited in claim 6, wherein the first one of the plurality of corners and the second one of the plurality of corners are adjacent to one another.

8. The mooring system as recited in claim 6, wherein,
the floater comprises a platform which is formed from a plurality of buoyant elements joined by a plurality of generally rigid connecting elements, and
one of the plurality of buoyant elements is provided at each of the plurality of corners of the foundation structure.

9. The mooring system as recited in claim 8, wherein the floater further comprises a wind turbine which is supported on a foundation structure.
